(19) United States
(12) Patent Application Publication
(10) Pub. No.: US 2013/0111329 A1
(43) Pub. Date: May 2, 2013

(54) HINTING SYSTEM AT USER INTERFACE DESIGN TIME

(71) Applicants: Ranjesh Gandhi Jaganathan, Bellevue, WA (US); Lester Oscar Lobo, Redmond, WA (US)

(72) Inventors: Ranjesh Gandhi Jaganathan, Bellevue, WA (US); Lester Oscar Lobo, Redmond, WA (US)

(73) Assignee: MICROSOFT CORPORATION, Redmond, WA (US)

(21) Appl. No.: 13/284,707

(22) Filed: Oct. 28, 2011

(51) Int. Cl. G06F 3/01; G06F 17/00

(52) U.S. Cl. 715/239; 715/708; 715/234

(57) ABSTRACT

The present invention extends to methods, systems, and computer program products for facilitating the usage of a static analysis based hinting system at user interface design time within a user interface development platform. The static analysis based hinting system enables a developer to identify and apply improvements that can be made to the design of a user interface while the developer is designing the user interface. User interface design hints that apply to user interface elements defined by the developer are identified. The user interface design hints provide recommendations for improving the design of corresponding user interface elements. These recommendations can be applied to modify the definition of a user interface element at design time including changing the type or property of a user interface element, adding or removing a property or other component of a user interface element, etc.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

Most computer applications employ a user interface for interacting with a user of the application. As the user interface is the user's view of the application, it is important that the user interface is user friendly and performs well. Designing such user interfaces, however, can be difficult because many user interface development platforms provide great flexibility in design, and developers of such platforms oftentimes do not know the optimal design for a given user interface feature.

As a result, the user interface designer may select a feature or component for a user interface that is less optimal and may need to be fixed or replaced at a later stage in the design process of the application. Generally, however, modifying the user interface design at a later stage of the design process increases the cost of the design. Accordingly, developers generally prefer being able to identify and resolve potential design issues at the earliest possible stage of the design process.

### BRIEF SUMMARY

The present invention extends to methods, systems, and computer program products for facilitating the usage of a static analysis based hinting system at user interface design time within a user interface development platform. The static analysis based hinting system enables a developer to identify and apply improvements that can be made to the design of a user interface while the developer is designing the user interface.

In one embodiment, user input is received at a user interface development platform. The user input defines a user interface element. The user interface element type is identified. A plurality of user interface design hints is accessed. Each of the plurality of user interface design hints indicate a specific manner for improving a user interface by improving a user interface element defined in accordance with a specified user interface element type. One or more of the plurality of user interface design hints are identified as apply to the identified user interface element type. The received user input is modified in accordance with the one or more user interface design hints to improve the user interface.

In another embodiment, a definition of a user interface is accessed, the definition comprising a markup language definition of each of a plurality of user interface elements. The markup language definitions are converted into a document object model. The document object model is analyzed to determine a type of each defined user interface element. A plurality of user interface design hints are accessed, each of the plurality of user interface design hints indicating a manner in which a corresponding type of user interface element can be defined to improve a user interface that includes the corresponding type of user interface element. For at least one user interface element defined in the document object model, it is determined that one or more of the plurality of user interface design hints apply to the at least one user interface element. The markup language definition of the at least one user interface element is then modified in accordance with the one or more user interface design hints to improve the user interface.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates the usage of a static analysis based hinting system at user interface design time within a user interface development platform.

FIG. 2 illustrates a more detailed view of a user interface of the user interface development platform shown in FIG. 1.

FIG. 3 illustrates a screenshot of an exemplary user interface of a user interface development platform that provides a static analysis based hinting system.

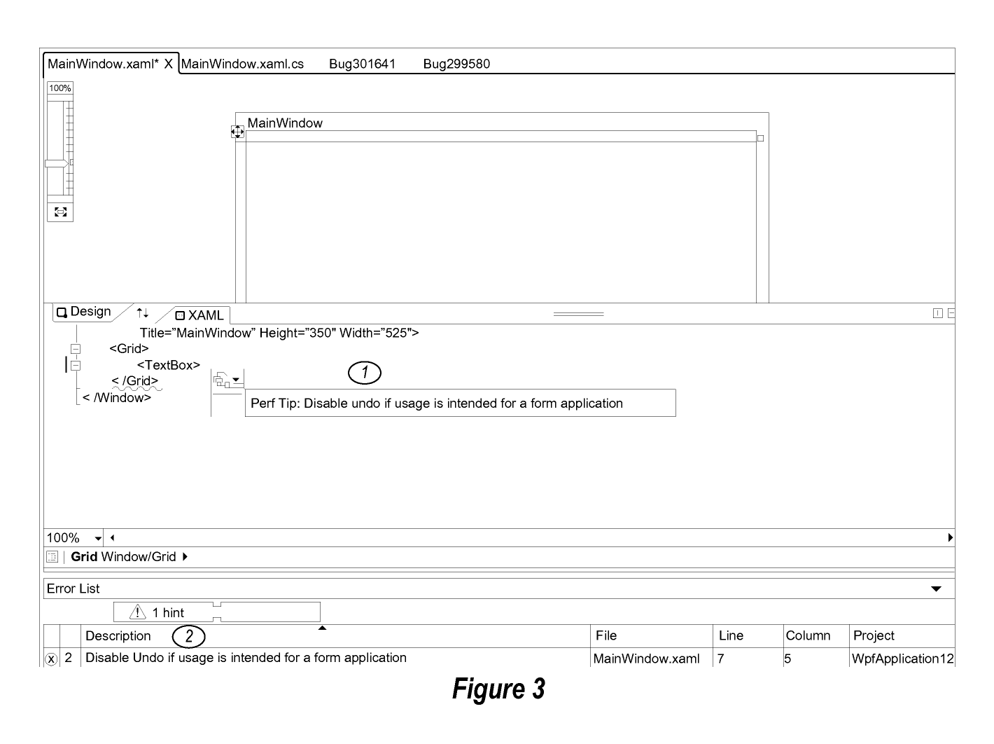

FIG. 4 illustrates a flow chart of an example method for facilitating the usage of a static analysis based hinting system at user interface design time within a user interface development platform.

FIG. 5 illustrates a flow chart of another example method for facilitating the usage of a static analysis based hinting system at user interface design time within a user interface development platform.

### DETAILED DESCRIPTION

The present invention extends to methods, systems, and computer program products for facilitating the usage of a static analysis based hinting system at user interface design time within a user interface development platform. The static analysis based hinting system enables a developer to identify and apply improvements that can be made to the design of a user interface while the developer is designing the user interface.

In one embodiment, user input is received at a user interface development platform. The user input defines a user interface element. The user interface element type is identified. A plurality of user interface design hints is accessed. Each of the plurality of user interface design hints indicate a specific manner for improving a user interface by improving a user interface element defined in accordance with a specified user interface element type. One or more of the plurality of user interface design hints are identified as apply to the identified user interface element type. The received user input is modified in accordance with the one or more user interface design hints to improve the user interface.

In another embodiment, a definition of a user interface is accessed, the definition comprising a markup language definition of each of a plurality of user interface elements. The markup language definitions are converted into a document object model. The document object model is analyzed to determine a type of each defined user interface element. A plurality of user interface design hints are accessed, each of the plurality of user interface design hints indicating a manner in which a corresponding type of user interface element can be defined to improve a user interface that includes the corresponding type of user interface element. For at least one user interface element defined in the document object model, it is determined that one or more of the plurality of user interface design hints apply to the at least one user interface element. The markup language definition of the at least one user interface element is then modified in accordance with the one or more user interface design hints to improve the user interface.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

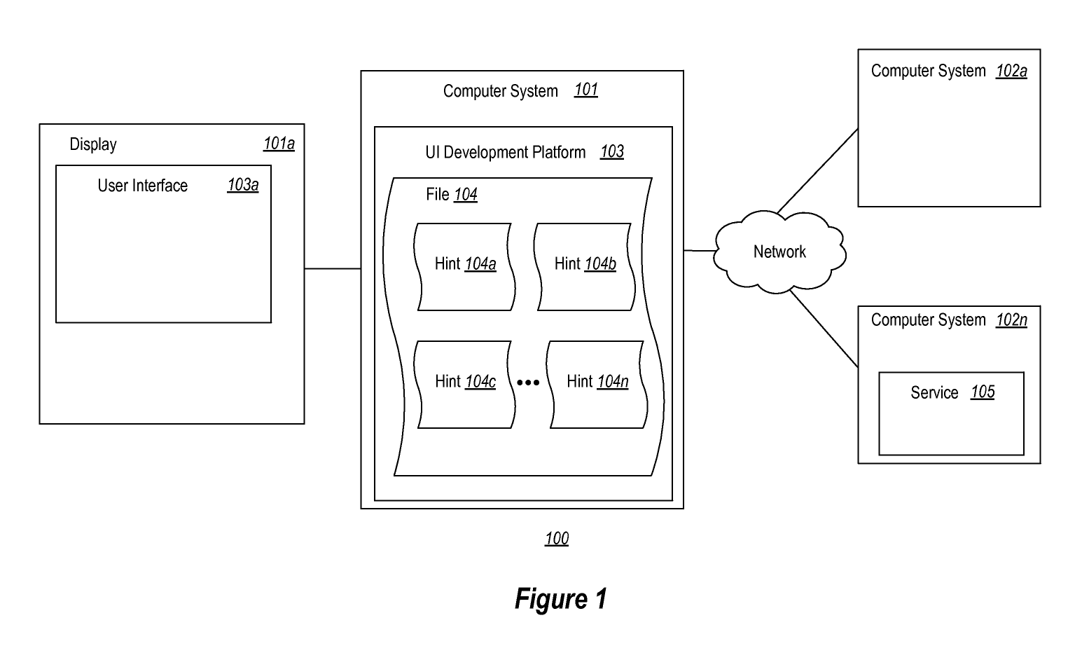

FIG. 1 illustrates an example computer architecture 100 that facilitates the usage of a static analysis based hinting system at user interface design time within a user interface development platform. Referring to FIG. 1, computer architecture 100 includes computer system 101 and one or more computer systems 102a-102n. Each of the depicted computer systems is connected to one another over (or is part of) a network, such as, for example, a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Computer system 101 is not limited to a physical computer system. For example, computer system 101 can represent a virtual machine in which the components of the present invention are executed. Additionally, such a virtual machine can be hosted within a cloud of computing systems. Accordingly, the present invention can be implemented within various different environments including physical and virtual environments.

Computer system 101 includes user interface development platform 103. User interface development platform 103 is a development environment in which developers can design user interfaces by inputting instructions and/or graphical representations of user interface elements to define the components of the user interfaces. User interface development platform 103 provides user interface 103a, that can be displayed on display 101a, in which the developer provides input.

While a developer is defining the components of a user interface within user interface 103a, user interface development platform 103 can provide user interface design hints that can improve the design of the user interface. For example, as the developer inputs code to define a user interface element, user interface development platform 103 can provide user interface design hints back to the user. The user interface design hints indicate how the user interface element has been defined by other developers, provides suggestions provided by other developers for designing user interface elements of the same type, etc.

The user interface design hints can be stored in one or more files (e.g. file 104). The files can be stored locally on computer system 101 and/or remotely on any of computers 102a-102n (e.g. file 104 can be stored in a cloud of computer systems). For example, file 104 can include user interface design hints 104a-104n. In some embodiments, a local file and a remote file can be accessed to obtain user interface design hints. In embodiments where file 104 is stored locally, updates to file 104 may be received to add or remove user interface design hints from file 104. In some embodiments, file 104 is structured as an XML document so that user interface design hints 104a-104n can be easily parsed. User interface development platform 103 can access file 104 to analyze the user interface definition as will be further described below.

Alternatively, the user interface design hints can be provided via a service accessible to user interface development platform 103. For example, service 105 hosted on computer system 102n can provide interfaces through which user interface development platform 103 accesses the user interface design hints. Although service 105 is shown as being hosted on computer system 102n, it could also be hosted within a cloud of computer systems.

In some embodiments, service 105 can provide interfaces for accessing available user interface design hints and analyzing the user interface definition in view of the user interface design hints. In other embodiments, service 105 can provide interfaces through which user interface development platform 103 submits portions of or the entire user interface definition for analysis by service 105. In response, service 105 provides appropriate user interface design hints back to user interface development platform 103.

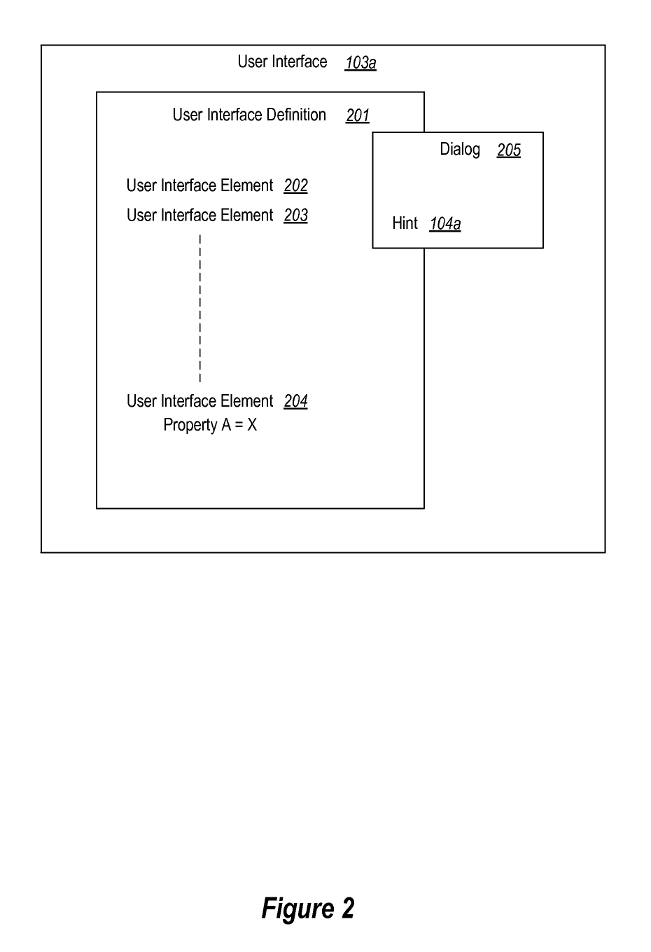

FIG. 2 illustrates a more detailed view of user interface 103a. As depicted, a developer provides input into user interface 103a to create user interface definition 201. Upon receiving input that defines a user interface element such as user interface element 202, 203, or 204, user interface development platform 103 analyzes the input to determine the type of user interface element that the input defines. For example, user interface development platform 103 can detect a tag in the input such as, for example, a XAML tag. XAML tags are structured as a type name between an opening angle bracket and a closing angle bracket such as <Button>, <TextBlock>, <Grid>, <Label>, etc. In such embodiments, user interface development platform 103 can identify a user interface element type by its name.

In some embodiments, determining a user interface element type can be performed by matching keywords within the developer input to keywords defined in file 104. For example, each of user interface design hints 104a-104n can include a keyword that identifies the user interface element type to which the user interface design hint applies. When a user interface definition is in XAML, the keyword can be the type name of the XAML tag. When file 104 is structured as an XML document, the keywords can be stored in nodes of the XML document. User interface design hints applicable to a user interface element type identified by the keyword can be stored within the keyword's node.

In addition to detecting the user interface element type, user interface development platform 103 can also detect other characteristics of the definition of the user interface element including properties, events, styles, templates, extensions, etc. For example, user interface element 204 includes a definition of a property A that is set to X. XAML tags are an example of user interface element definitions that can include the definition of various properties associated with the user interface element that the XAML tag defines. For example, a XAML user interface element may include a property of RenderOptions.BitmapScalingMode that can be set to various values.

User interface development platform 103 can detect the presence of such characteristics in a manner similar to how a user interface element type is determined. For example, keyword matching can be used to determine the use (or the lack of use) of any of these characteristics within a user interface element definition. In some embodiments, a user interface definition can be converted from markup into a document object model (DOM) to facilitate a more detailed analysis of the user interface definition. For example, if user interface definition 201 were in a markup language such as XAML, HTML, or XML, the markup can be converted into a DOM.

In some embodiments, such as when XAML is used to define user interface elements, user interface development platform 103 can also analyze the code-behind files (e.g. which define the run-time logic of the user interface definition) to determine characteristics of the definition of the run-time logic.

After analyzing the input, user interface development platform 103 accesses user interface design hints 104a-104n. User interface development platform 103 determines which of user interface design hints 104a-104n are applicable to any of the user interface elements defined in user interface definition 201. For example, user interface development platform 103 can determine that user interface design hint 104a applies to user interface element 202 by matching a keyword in the definition of user interface element 202 to a keyword in user interface design hint 104a. User interface development platform 103 can also determine whether a user interface design hint applies to a definition of a user interface element by determining whether the definition already matches the user interface design hint.

After determining that a user interface design hint applies to a user interface element, user interface development platform 103 can display the user interface design hint with an indication of the user interface element to which the user interface design hint applies. For example, user interface 103a can display user interface design hint 104a with an indication that user interface design hint 104a applies to user interface element 202.

As depicted in FIG. 2, user interface design hint 104a is displayed in a popup dialog 205. Dialog 205 can also display one or more other user interface design hints that apply to the same or other user interface elements defined in user interface definition 201 (not shown). Dialog 205 can also display an indication of the user interface element to which each user interface design hint applies such as by displaying a line number within user interface definition 201 on which the corresponding user interface element is defined (or on which the definition begins). In other embodiments, popup dialog 205 can be specific to a single user interface element (i.e., contain only user interface design hints applicable to the single user interface element) and configured as a balloon that points to the user interface element to which it applies. In such embodiments, a balloon can be displayed for each user interface element determined to have a matching user interface design hint.

Other means of displaying user interface design hints can be also used. For example, user interface design hints can be displayed in a separate frame of user interface 103a, or each user interface design hint can be displayed in a manner that directly links the user interface design hint to the user interface element to which it applies. For example, a user interface element can be highlighted and/or can provide a popup window that displays the user interface design hint when hovered over. In other embodiments, the modifications proposed by a user interface design hint can be automatically applied to the definition of a user interface element in a manner that identifies the modifications similar to how changes are tracked in a word processing document (e.g. strikethrough for deletions and underline for additions).

When a user interface design hint is applied (whether by selection or automatically), the definition of a user interface element is modified to conform to the recommendation provided in the user interface design hint. For example, user interface design hint 104a can be applied to user interface element 202 to change the type of user interface element 202 (e.g. from <PathGeometry> to <StreamGeometry>, from <listbox> to <gridview> or <listview>, etc.), to change a property of user interface element 202 (e.g. setting the property RenderOptions.BitmapScalingMode to LowQuality), to add or remove an element, property, or other component (e.g. adding a StaticResource extension to the definition of user interface element 202, or removing or deactivating a property of user interface element 202), to merge two or more portions of the user interface definition that are duplicative (e.g. merging user interface elements 202 and 203 if it is determined that they perform a similar function that can be performed by a single user interface element), or any other modification to user interface definition 201 that is recommended by a user interface design hint.

Although the above description describes the analysis of the input occurring automatically upon the input being received, in some embodiments of the invention, the analysis can be performed at a time specified by a developer. For example, user interface development platform 103 can include a configurable option to enable the developer to specify whether input analysis is to be performed as the input is supplied, or in response to the developer requesting that the analysis be performed.

Embodiments of the invention also include compiling user interface design hints into one or more files or services that are accessible to developers using user interface development platform 103. Such embodiments can provide an interface through which users can submit user interface design hints. The interface can enable a user to directly submit a user interface design hint in the appropriate format for inclusion in file 104, for example, or can store a submitted user interface design hint for subsequent review prior to the user interface design hint being added to file 104. For example, a submitted user interface design hint can be published for review by one or more administrators of the hinting system or by the community of developers of user interface definitions prior to adding the user interface design hint to file 104.

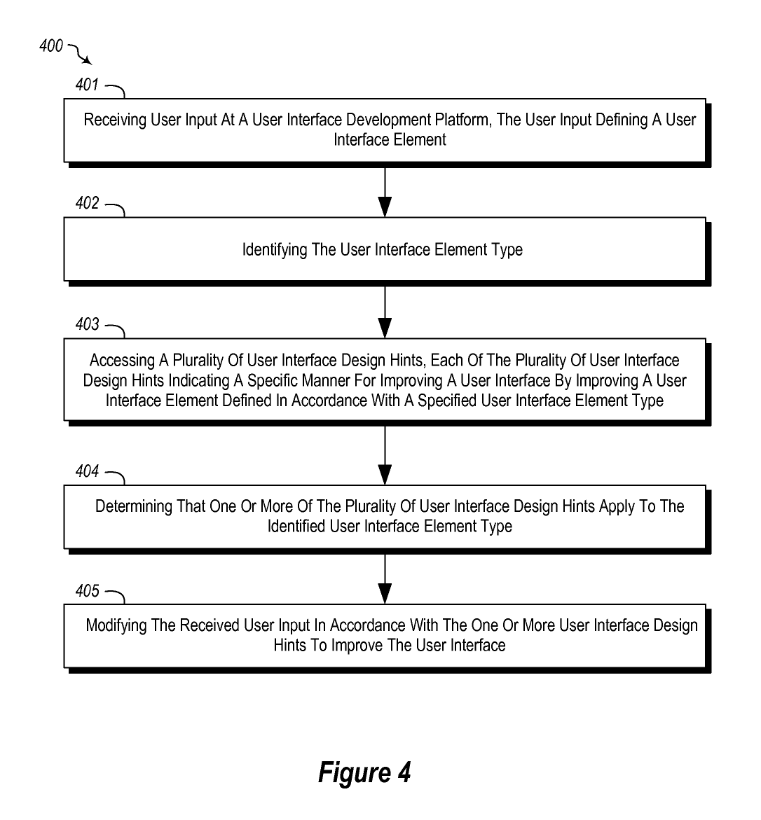

FIG. 4 illustrates a flow chart of an example method 400 for providing user interface design hints to a developer during the design of a user interface to improve the user interface. Method 400 will be described with respect to the components and data of computer architecture 100 shown in FIGS. 1 and 2.

Method 400 includes an act 401 of receiving user input at a user interface development platform, the user input defining a user interface element. For example, user input can be received at user interface 103a within user interface definition 201 that defines user interface element 202. The input can be in XAML

Method 400 includes an act 402 of identifying the user interface element type. For example, user interface development platform 103 can analyze the definition of user interface elements 202, 203, and 204 to determine the type of user interface element that each definition defines. Analyzing the input can include identifying a keyword within each definition of a user interface element.

Method 400 includes an act 403 of accessing a plurality of user interface design hints, each of the plurality of user interface design hints indicating a specific manner for improving a user interface by improving a user interface element defined in accordance with a specified user interface element type. For example, user interface development platform 103 can access user interface design hints 104a-104n. The plurality of user interface design hints can be accessed locally or remotely from a file, such as file 104, or from a service.

Method 400 includes an act 404 of determining that one or more of the plurality of user interface design hints apply to the identified user interface element type. For example, user interface development platform 103 can determine that user interface design hint 104a applies to the definition of user interface element 202. This determination can be based on the definition of user interface element 202 containing a keyword that matches a keyword stored with user interface design hint 104a. This determination can also be based on the definition of user interface element 202 containing one or more properties or other characteristics that match user interface design hint 104a.

Method 400 includes an act 405 of modifying the received user input in accordance with the one or more user interface design hints to improve the user interface. For example, user interface design hint 104a can be applied to the definition of user interface element 202 to modify the definition. This modification can include changing the type of user interface element 202, or changing, adding, or removing a property or other characteristics of user interface element 202.

In some embodiments, method 400 can also include, prior to modifying the user input that defines the user interface element, displaying each of the one or more user interface design hints that are determined to apply to the identified user interface element type, and receiving user input that selects the displayed one or more user interface design hints. For example, user interface design hint 104a can be displayed within user interface 103a in a manner that allows a developer to select user interface design hint 104a.

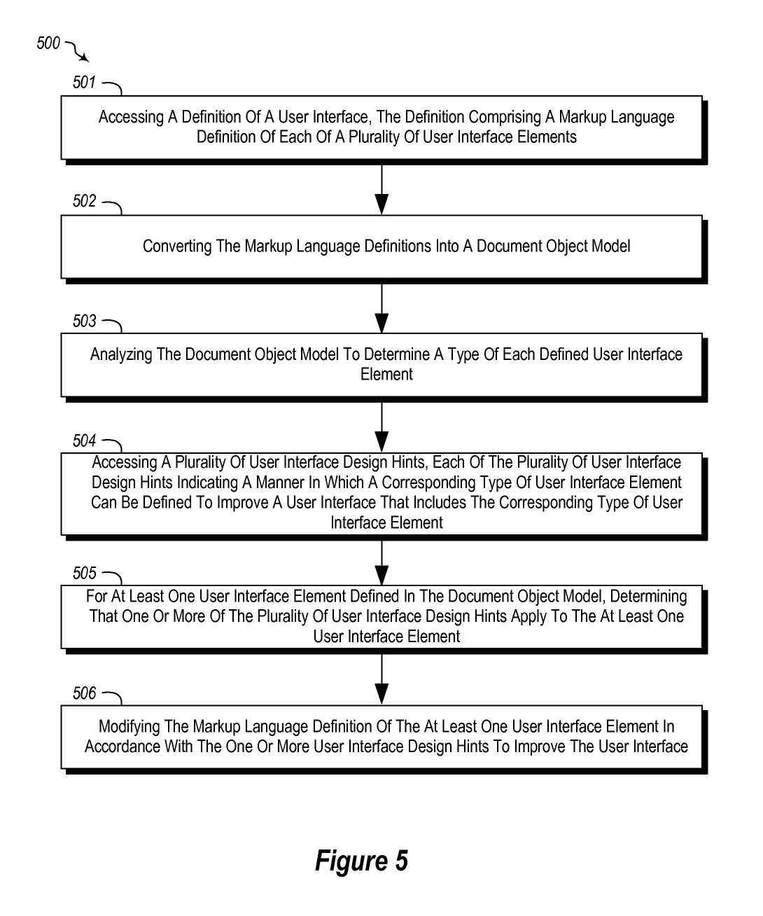

FIG. 5 illustrates a flow chart of another example method 500 for providing user interface design hints to a developer during the design of a user interface to improve the user interface. Method 500 will be described with respect to the components and data of computer architecture 100 shown in FIGS. 1 and 2.

Method 500 includes an act 501 of accessing a definition of a user interface, the definition comprising a markup language definition of each of a plurality of user interface elements. For example, user interface development platform 103 can access user interface definition 201 that defines user interface elements 202, 203, and 204.

Method 500 includes an act 502 of converting the markup language definitions into a document object model. For example, user interface development platform 103 can convert user interface definition 201 into a document object model.

Method 500 includes an act 503 of analyzing the document object model to determine a type of each defined user interface element. For example, user interface development platform 103 can analyze the document object model of user interface definition 201 to determine the type of user interface elements 202, 203, and 204.

Method 500 includes an act 504 of accessing a plurality of user interface design hints, each of the plurality of user interface design hints indicating a manner in which a corresponding type of user interface element can be defined to improve a user interface that includes the corresponding type of user interface element. For example, user interface development platform 103 can access user interface design hints 104a-104n. The plurality of user interface design hints can be accessed locally or remotely from a file, such as file 104, or from a service.

Method 500 includes an act 505 of, for at least one user interface element defined in the document object model, determining that one or more of the plurality of user interface design hints apply to the at least one user interface element. For example, user interface development platform 103 can determine that user interface design hint 104a applies to the definition of user interface element 202. This determination can be based on the document object model of user interface definition 201 specifying that the definition of user interface element 202 contains a keyword that matches a keyword stored with user interface design hint 104a. This determination can also be based on the document object model of user interface definition 201 specifying one or more properties or other characteristics of user interface element 202 that match user interface design hint 104a.

Method 500 includes an act 506 of modifying the markup language definition of the at least one user interface element in accordance with the one or more user interface design hints to improve the user interface. For example, user interface development platform 103 can modify the markup language definition of user interface element 202. This modification can include changing the type of user interface element 202, or changing, adding, or removing a property or other characteristic of user interface element 202.

In some embodiments, method 500 can also include, prior to modifying the markup language definition of the at least one user interface element, displaying each of the one or more user interface design hints that are determined to apply to the identified type of user interface element, and receiving user input that selects the displayed one or more user interface design hints. For example, user interface design hint 104a can be displayed within user interface 103a in a manner that allows a developer to select user interface design hint 104a.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system, the computer system including a user interface development platform for designing user interfaces, a method for providing user interface design hints to a developer during the design of a user interface to improve the user interface, the method comprising:
receiving user input at a user interface development platform, the user input defining a user interface element;
identifying the user interface element type;
accessing a plurality of user interface design hints, each of the plurality of user interface design hints indicating a specific manner for improving a user interface by improving a user interface element defined in accordance with a specified user interface element type;
determining that one or more of the plurality of user interface design hints apply to the identified user interface element type; and
modifying the received user input in accordance with the one or more user interface design hints to improve the user interface.

2. The method of claim 1, wherein the input is in XAML.

3. The method of claim 1, wherein prior to modifying the received user input in accordance with the one or more user interface design hints to improve the user interface, the method comprises:
displaying each of the one or more user interface design hints that are determined to apply to the identified user interface element type; and
receiving user input that selects the displayed one or more user interface design hints.

4. The method of claim 3, wherein displaying each of the one or more user interface design hints that are determined to apply to the identified user interface element type comprises displaying an indication of each user interface design hint in conjunction with an indication of the user interface element to which the user interface design hint applies.

5. The method of claim 1, wherein identifying the user interface element type comprises identifying a keyword in the input that defines the user interface element type.

6. The method of claim 1, wherein accessing a plurality of user interface design hints further comprises accessing a locally or remotely stored file that contains the plurality of user interface design hints.

7. The method of claim 6, wherein the locally or remotely stored file is an XML file.

8. The method of claim 1, wherein accessing a plurality of user interface design hints further comprises accessing a service to request the plurality of user interface design hints.

9. The method of claim 1, wherein modifying the received user input in accordance with the one or more user interface design hints to improve the user interface further comprises replacing at least some of the input that defines the user interface element with input as defined in the one or more user interface design hints.

10. The method of claim 1, wherein modifying the received user input in accordance with the one or more user interface design hints to improve the user interface further comprises adding or removing input as defined in the one or more user interface design hints to the user input that defines the user interface element.

11. The method of claim 1, wherein the plurality of user interface design hints are based on definitions of user interface elements used by other developers in a plurality of other user interfaces.

12. The method of claim 1, wherein improving the user interface comprises improving the performance of the user interface.

13. At a computer system, the computer system including a user interface development platform for designing user interfaces, a method for the user interface development platform to provide user interface design hints to a developer during the design of a user interface to improve the user interface, the method comprising:
accessing a definition of a user interface, the definition comprising a markup language definition of each of a plurality of user interface elements;
converting the markup language definitions into a document object model;
analyzing the document object model to determine a type of each defined user interface element;
accessing a plurality of user interface design hints, each of the plurality of user interface design hints indicating a manner in which a corresponding type of user interface element can be defined to improve a user interface that includes the corresponding type of user interface element;
for at least one user interface element defined in the document object model, determining that one or more of the plurality of user interface design hints apply to the at least one user interface element; and
modifying the markup language definition of the at least one user interface element in accordance with the one or more user interface design hints to improve the user interface.

14. The method of claim 13, wherein prior to modifying the markup language definition of the at least one user interface element in accordance with the one or more user interface design hints to improve the user interface, the method comprises:
displaying each of the one or more user interface design hints that are determined to apply to the identified type of user interface element; and
receiving user input that selects the displayed one or more user interface design hints.

15. The method of claim 13, wherein, for at least one user interface element defined in the document object model, determining that one or more of the plurality of user interface design hints apply to the at least one user interface element further comprises:
determining that the at least one user interface element includes a property that is set to a value; and
determining that one or more of the plurality of user interface design hints recommends that the property be set to a different value.

16. The method of claim 13, wherein for at least one user interface element defined in the document object model, determining that one or more of the plurality of user interface design hints apply to the at least one user interface element further comprises:
determining that one or more of the plurality of user interface design hints recommends that a different type of user interface element be used instead of the user interface element defined in the document object model.

17. The method of claim 13, wherein modifying the markup language definition of the at least one user interface element in accordance with the one or more user interface design hints to improve the user interface further comprises replacing at least some of the input that defines the user interface element with input as defined in the one or more user interface design hints.

18. The method of claim 13, wherein modifying the markup language definition of the at least one user interface element in accordance with the one or more user interface design hints to improve the user interface further comprises adding or removing input as defined in the one or more user interface design hints to the definition of the user interface element.

19. The method of claim 13, wherein accessing a plurality of user interface design hints comprises accessing a local file storing the plurality of user interface design hints, the method further comprising:
receiving an update to the local file, the update comprising one or more additional user interface design hints to add to the local file.

20. At a computer system, the computer system including a user interface development platform for designing user interfaces, a method for providing user interface design hints to a developer during the design of a user interface to improve the user interface, the method comprising:
receiving XAML input to a user interface of a user interface development platform that defines a user interface definition which includes a plurality of user interface elements;
analyzing the XAML input to identify a type of each user interface element defined in the user interface definition;
accessing a file that stores a plurality of user interface design hints, each of the plurality of user interface design hints indicating a specific manner in which a corresponding type of user interface element can be defined to improve a user interface that includes the corresponding type of user interface element;
determining that one or more of the plurality of user interface design hints apply to the identified type of each of the user interface elements;
displaying each of the user interface design hints that are determined to apply to the identified type of each of the user interface elements;
receiving user input that selects one of the displayed user interface design hints that applies to a first type of user interface element; and
modifying the XAML input for each of the user interface elements of the first type such that the modified XAML input conforms to the selected user interface design hint, the modification including one or more of:
changing the type name within the XAML input so that the XAML input defines a user interface element of a different type;
changing a property within XAML input; or
adding a property to or removing a property from the XAML input.
